(19) United States
(12) Patent Application Publication
(10) Pub. No.: US 2017/0243311 A1
(43) Pub. Date: Aug. 24, 2017

(54) COMPUTER SYSTEM AND METHOD FOR PROVIDING ON-DEMAND REALTOR SERVICES

(71) Applicant: AGENT LYNX LLC., Austin, TX (US)

(72) Inventors: Daniel Brickley, Austin, TX (US); Nicholas Munoz, Austin, TX (US)

(21) Appl. No.: 15/434,761

(22) Filed: Feb. 16, 2017

Related U.S. Application Data
(60) Provisional application No. 62/297,575, filed on Feb. 19, 2016.

(51) Int. Cl. G06Q 50/16; G06Q 10/06

(52) U.S. Cl. CPC G06Q 50/16; G06Q 10/063112

(57) ABSTRACT

Computer-implemented methods to provide a prospective home buyer, an appointment with a real estate agent that is in close proximity to the prospective home buyer are described. A prospective home buyer can summon a real estate agent using her mobile device on an on-demand basis from near the home. Immediately thereafter, the appropriate real estate agent can be routed to the home buyer. Doing so home buyers to gain quick entry to tour a home without needing to make prior arrangements with a real estate agent. Real estate agents can be notified to meet a prospective home buyer interested in a home for sale that is in close vicinity at a point in time when the home buyer is available and willing to shop. A real estate agent that is best suited to show the home to the prospective buyer can be identified, thereby improving the buyer's home buying experience.

### TECHNICAL FIELD

This disclosure relates to computer-implemented methods, computer systems and computer-readable media implemented in real estate services.

### BACKGROUND

Prospective home buyers have access to a wealth of data concerning the housing market thanks to the pervasive presence of real estate services on the Internet. To gain physical entry to a house on the market, a prospective buyer works with a real estate agent. For this reason, a prospective home buyer makes arrangements with a real estate agent hours or days in advance to tour candidate homes. Another option for the buyer is to schedule some time to be accompanied by a real estate agent as they hunt for a home. This dependency on real estate agents restricts potential buyers from spontaneously searching for homes at their own leisure.

### SUMMARY

The present disclosure describes methods and systems, including computer-implemented methods, computer program products, and computer systems for on-demand realtor services using a data network.

Certain aspects of the subject matter described here can be implemented as a computer-implemented method by one or more computer server systems. A string of alphanumeric characters identifying a real property at a geographic location is received from a first mobile client computer system over a data transmission network. In response to receiving the string, a computer-readable storage medium is searched for a real property identifier uniquely identifying the real property identified by the received string. The computer-readable storage medium stores multiple strings, each including multiple alphanumeric characters; corresponding multiple real property identifiers, each uniquely identifying a respective real property, each associated with a corresponding string of the multiple strings; multiple real estate agent identifiers, each identifying a real estate agent qualified to show real property to prospective home buyers; and, for each real estate agent identifier, information describing a qualification of each real estate agent to show the real property to the prospective home buyers. In response to searching for the real property identifier uniquely identifying the real property identified by the received string, the real property identifier uniquely identifying the real property identified by the received string is retrieved. Based on the information describing the qualification of each real estate agent to show the real property to the prospective home buyers, one or more real estate agent identifiers, each identifying a real estate agent qualified to show the real property at the geographic locations are determined. To each of one or more second mobile client computer systems associated with the respective identified one or more real estate agent identifiers, a request message is transmitted over the data transmission network. The request message requests each real estate agent to show the real property at the geographic location. The second mobile client computer system is associated with the real estate agent determined to show the real property at the geographic location.

This, and other aspects, can include one or more of the following features. In response to transmitting the request message to each real estate agent, an acceptance message accepting the request message can be received from a second mobile computer system over the data transmission network. The second mobile device is associated with a real estate agent identifier included in the determined one or more real estate agent identifiers. In response to receiving the acceptance message, the real estate agent identifier identifying the real estate agent and at least a portion of the identified real estate agent that is associated with the identified real estate agent identifier can be transmitted to the first mobile client computer system.

One or more of the earlier-described aspects can include one or more of the following features. A resource including the real estate agent identifier identifying the determined real estate agent and at least the portion of the qualification can be generated. A Uniform Resource Locator (URL) to identify the resource can be generated and transmitted to the first mobile client computer system.

One or more of the earlier-described aspects can include one or more of the following features. Multiple real property identifiers, real estate agent identifiers and, for each real estate agent, information describing the qualification of each real estate agent to show the real property to the prospective home buyers can be received and stored in the computer-readable storage medium. Multiple strings of alphanumeric characters can be generated for the corresponding multiple real property identifiers. The multiple strings can be stored in the computer-readable storage medium. To each real property identified by a respective real property identifier, a corresponding string of alphanumeric characters can be transmitted over the data transmission network.

One or more of the earlier-described aspects can include one or more of the following features. The string of alphanumeric characters can include a telephone number. The data transmission network can be a cellular network. The request message can be a text message sent via Short Message Service (SMS).

One or more of the earlier-described aspects can include one or more of the following features. To determine the real estate agent identifier based on the information describing the qualification of each real estate agent, a subset of real estate agent identifiers can be identified from among the multiple real estate agent identifiers. The subset can have at least two real estate agent identifiers and fewer real estate agent identifiers then the plurality of real estate agent identifiers. The subset can be ranked based on the information describing the qualification of each real estate agent represented by a real estate agent identified included in the subset. A real estate agent identifier with a highest ranked real estate agent can be identified. When transmitting a request message to each real estate agent identified, a first request message can be transmitted to a higher ranked real estate agent identifier at a first time instant. A request message transmission can be delayed by a duration from the first time instant. A second request message can be transmitted to a lower ranked real estate agent identifier at a second time instant after the duration has expired. The subset can be ranked based on a price associated with the real property.

Certain aspects of the subject matter described here can be implemented as a computer-readable medium (for example, a non-transitory computer-readable medium) storing computer-readable instructions to perform the computer-implemented method. Certain aspects of the subject matter described here can be implemented as a computer-implemented system including a computer memory interoperably coupled with a hardware processor configured to perform the computer-implemented method/the instructions stored on the computer-readable medium.

The details of one or more implementations of the subject matter of this specification are set forth in the accompanying drawings and the description. Other features, aspects, and advantages of the subject matter will become apparent from the description, the drawings, and the claims.

### DESCRIPTION OF DRAWINGS

FIG. 1A is a schematic illustrating an example workflow to prepare homes for on-demand agents, according to an implementation.

FIG. 1B is a schematic illustrating an example workflow to request an on-demand agent, according to an implementation.

FIG. 2 is a flowchart illustrating an example method for realtor services using the data network, according to an implementation.

FIG. 3 is a block diagram illustrating an example computer system used to provide computational functionalities associated with described algorithms, methods, functions, processes, flows, and procedures as described in this disclosure, according to an implementation.

FIG. 4 is a flowchart illustrating an example method implemented by the example computer system of FIG. 3.

Like reference numbers and designations in the various drawings indicate like elements.

### DETAILED DESCRIPTION

This disclosure relates to computer-implemented methods to provide a prospective home buyer, an appointment with a real estate agent that is in close proximity to the prospective home buyer. Techniques described in this disclosure can be implemented to enable prospective home buyers to summon the nearest real estate agent using their mobile devices (for example, smart phones, tablet computers, or other mobile computer systems) once they discover a home they wish to tour. In particular, a home buyer can summon the real estate agent on an on-demand basis. That is, in response to receiving a request from a home buyer for a real estate agent and at a time instant at which the request is received, a search from among multiple real estate agents can be performed to identify the appropriate real estate agent. Immediately thereafter, the appropriate real estate agent can be routed to the home buyer. Doing so home buyers to gain quick entry to tour a home without needing to make prior arrangements with a real estate agent. Real estate agents can be notified to meet a prospective home buyer interested in a home for sale that is in close vicinity at a point in time when the home buyer is available and willing to shop. In addition, a real estate agent that is best suited to show the home to the prospective buyer can be identified, thereby improving the buyer's home buying experience.

The techniques described in this disclosure can be implemented to categorize real estate agents and homes into different tiers to improve a user's home buying experience. For example, real estate agents and homes can be categorized into multiple tiers such as low-tier, mid-tier and high-tier. When a request to view a high-tier home is received, a high-tier agent can be selected to show the home. The techniques can be implemented to determine a level of home selling service to be applied to different geographic areas. For example, when a number of requests received from a particular neighborhood increases over a duration, agents can be notified of the increase, which may result in agents focusing on the particular neighborhood. The techniques can be implemented to collect real estate buying and selling data and produce insight. The analytics can be used to identify successful agents, geographic areas with most leads, average response time to respond to a buyer's request to view a home, the average time it takes a buyer to cancel a request, and other useful and valuable data. Historical data can be used to predict the geographic areas that yield the most leads over different times of the day, and can use the live geographic location of agents to generate a plan on re-dispatching agents to maximize lead generation success.

Several implementations of the subject matter are disclosed in this disclosure from the perspective of real estate buying and selling. The real estate can be residential or commercial or both. The techniques can also be applied to real estate rental. For example, the techniques can be used to provide an on-demand agent to a prospective tenant interested in renting property. The rental property can be residential or commercial or both.

The techniques described here can result in a decrease and optimization of resources consumed by a data network. In some examples, a user uses a client computer system (for example, a desktop computer, a laptop computer, a tablet computer, a smartphone or other client computer system) to view a home listed on the real estate website. One or more computer servers hosting the real estate website present, on the client computer system, information describing the home. The information includes, for example, pictures or videos (or both) of the home, specifications of the home (such as size, number of rooms, and the like), neighborhood, schools, and other information. The information also includes one or more real estate agents that may be able to show the home to the user. For example, for each agent, the computer server can transmit to the client computer system, identifying information (such as name, image, contact information, and the like) associated with the agent. The computer servers receive information about the agents from the agents themselves, and expend resources to store, process and present the information. The client computer system can display information describing the home and information associated with the one or more real estate agents. The user can select one of the agents, and, if interested, schedule an appointment to view the home. Details of the appointment can be stored on the client side or the server side (or both).

Each item of information describing the home and each item of information associated with an agent is a resource that the computer servers store and maintain. Each request received from the client computer system and to which the computer server responds expends computer resources, not to mention network bandwidth when the requests and responses are exchanged over data networks. On the client side, the client computer system also expends significant resources to receive information from the computer server, to present the information on a display of the client computer system, to receive requests from the user, to transmit the request to the computer server, and to save any appointments that the user makes to view the home. The expenditure of resources is further compounded, at least at the computer server end, by several hundred (if not thousand) users simultaneously accessing the computer servers.

The techniques described here can be implemented to decrease the expenditure of resources described above, thereby optimizing and improving operation of the computer servers and the client computer systems, and saving network bandwidth. Because a real estate agent can be made available to a user on an on-demand basis, the computer servers hosting the real estate website need not present information associated with the agents to client computer systems together with information describing homes. Upon receiving a request to present a home, the computer servers need not expend resources to search computer-readable memory for information associated with the real estate agents, to process the results of the search, to package the results in a manner that can be presented on a client computer system, or to transmit the package over data networks to the client computer system. Thus, the resources expended by the computer servers and the data exchange over computer networks are optimized resulting in an increase in operational efficiency of the computer servers and the computer networks.

Because a prospective home buyer is connected with a real estate agent on the on-demand basis, the buyer's client computer system need not store the information associated with real estate agents on the client computer system. For example, a user need not store on her smartphone, details about an upcoming appointment with a real estate agent at a home. When such decrease in storage and resource processing is extrapolated across the several hundred or thousand client computer systems, the increase in efficiency of the overall computer servers-client computer systems universe and the computer networks that connect them become significant.

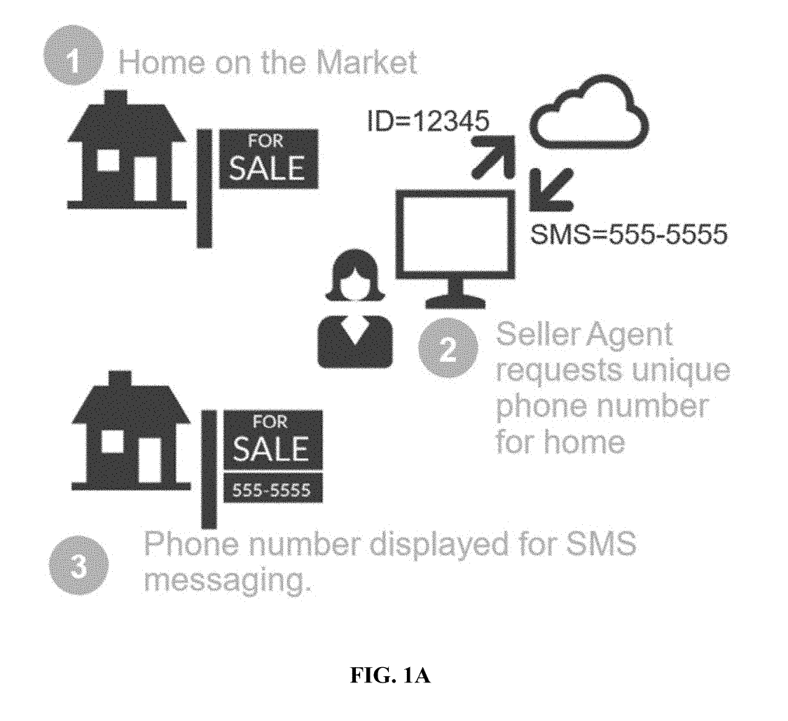

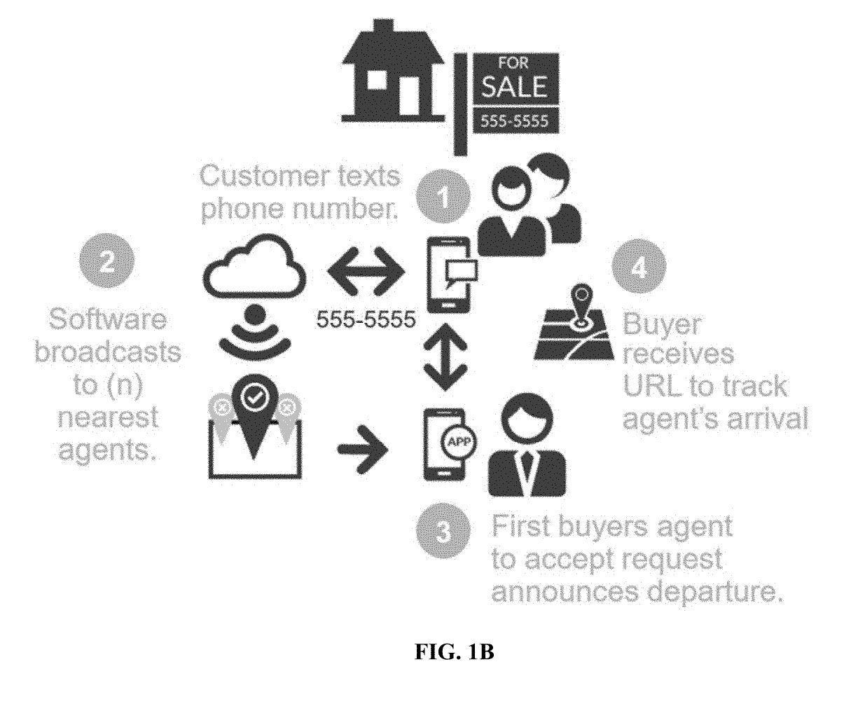

FIGS. 1A and 1B show example workflows of implementations of the subject matter described here. FIG. 1A is a schematic illustrating an example workflow to prepare homes for on-demand agents, according to an implementation. To prepare a home for on-demand agents, the home is first included among a list of multiple homes, each of which is associated with one or more real estate agents. For example, a home for sale (1) is assigned a unique identifier which is added to a database storing multiple homes for sale. The home for sale (1) is assigned contact information that is unique to the home. The contact information can include, for example, a telephone number, an instant message identifier or other unique contact information. As described below, when a user desires a showing of the home for sale (1), the user can communicate with an on-demand real estate agent using the contact information assigned to the home for sale (1). The contact information can be displayed at the physical location of each home. For example, the contact information can be displayed together with the “FOR SALE” sign in front of each home. In this manner, multiple homes for sale can be prepared for on-demand agents by assigning respective unique identifiers to the multiple homes, storing the multiple identifiers in the database storing multiple homes for sale, by assigning, to each home, respective contact information, and by providing the contact information to be displayed with the homes. In some implementations, the contact information can be, for example, a telephone number, a bar code, an e-mail address, a QR code, or other contact information. The contact information can be shared in many ways. For example, the contact information can be displayed on a “FOR SALE” sign near the home. Alternatively, or in addition, the contact information can be presented on the home itself. A user can use a mobile client computer system (for example, a cell phone, a smart phone, a laptop computer, a tablet computer or other mobile client computer system) to contact the data center using the contact information.

The contact information can be generated and managed by the data center. For example, the data center can generate sets of contact information (for example, pools of telephone numbers or e-mail addresses or bar codes) based on geographic areas in which the homes are located. In some implementations, the contact information can be pre-generated and stored. When a listing agent registers a home for sale with the data center, the listing agent provides the home street address. In response, the data center determines the geographic coordinates for the home and assigns a pre-generated contact information to the home, and provide the contact information to the listing agent. In some implementations, the data center can generate the contact information in real time. For example, upon receiving a home for sale to be registered, the data center can determine the geographic coordinates and can generate the contact information in real time. The data center can then provide the contact information to the listing agent. The contact information is re-usable. That is, after a home has been sold, the data center can cancel the assignment of the contact information to the home, making the contact information available to be assigned to a different home.

As described above, in some implementations, the contact information can include a telephone number, and a telephone number can be uniquely assigned to a home. Alternatively, multiple homes can be assigned to the same telephone number (or e-mail address or other contact information), and each home can additionally be assigned a unique identifier, for example, a string of alphanumeric characters. For example, where multiple homes share a common feature (such as the same geographic area, the same brokerage, the same listing agent or other common feature), the data center can assign a common portion to the multiple homes and a unique identifier to each home. Thus, for a first home, the telephone number can be 555-555-5555 and the unique identifier can be “tour1”; for a second home, the telephone number can once again be 555-555-5555 and the unique identifier can be “tour2”. To tour the first home or the second home, the user can send the text message “tour1” or “tour2,” respectively, to 555-555-5555. Alternatively, the contact information can be a combination of the same e-mail address and the unique identifier. Other examples of combinations of contact information including a common portion and a unique identifier is also possible. When a home is sold, the data center re-uses the unique portion to a different home that shares the common feature. When all homes sharing the common feature are sold, the data center can re-use the common portion and the unique identifiers for a different group of homes sharing a common feature

FIG. 1B is a schematic illustrating an example workflow to request an on-demand agent, according to an implementation. A prospective buyer (customer) makes a request for an on-demand agent. To do so, the prospective buyer sends a communication, for example, a short message service (SMS) text message or other communication, to the contact number associated with the home. The type of communication can vary based on the type of contact information. For example, as described above, the contact information can be a phone number and the communication can be a text message. Alternatively, the communication can be a call to the phone number and an oral message identifying the home. In another example, the contact information can be an email address and the communication can include sending an email to the email address. In a further example, the contact information can be a bar code or a QR code, and the communication can include scanning the bar code or the QR code.

In some implementations, the data center can determine if the prospective buyer is near the home when sending the on-demand request to the data center. For example, if the prospective buyer transmits the on-demand request using a mobile client computer system whose geographic location can be tracked, the data center can determine if the geographic location of the mobile client computer system and that of the home are near each other (for example, within a distance threshold). If not, then the data center can track the mobile client computer system to determine if the mobile client computer system is moving toward the home within a duration (for example, 1 minute to 5 minutes) after receiving the on-demand request. If the mobile client computer system is determined to be neither near the home nor moving toward the home within the duration, then the data center can conclude that the on-demand request is not authentic and reject the request.

In some instances, the buyer may have left the home after sending the on-demand request. For example, the data center can determine that the mobile client computer system is near the home when the on-demand request is received, and, by implementing the techniques described here, direct a real estate agent to go to the home. Before the agent arrives, the buyer may have left. In such instances, the agent, via a mobile client computer system, can send a message to the data center indicating the absence of the buyer at the home. The data center can responsively send a message to the buyer's mobile client computer system. If the buyer does not return to the home, then the agent, via their mobile client computer system, can notify the data center that the on-demand request was a false lead. Alternatively, if the data center, by tracking the buyer's mobile client computer system, determines that the buyer has not returned home or is not headed towards the home, can mark the on-demand request as a false lead. When a request from a mobile client computer system has been marked as a false lead, the data center can flag the mobile client computer system for future on-demand requests. For example, the data center can decrease a priority assigned to requests from the flagged mobile client computer system or ban the flagged mobile client computer system and decline future on-demand requests.

In some implementations, the data center can assign a set of multiple identifiers to the home. A listing agent can present the identifiers at different locations on or around the home. For example, the set can include five identifiers displayed on the front of, top left corner of, top right corner of, bottom left corner of and bottom right corner of the “FOR SALE” sign. After receiving the on-demand request from a mobile client computer system, and to ensure that the buyer remains near the home, the data center can request the user to periodically transmit one of the multiple identifiers to the data center. For example, the data center determines the duration that it will take the determined real estate agent to arrive at the home. The data center can divide the duration by the total number of identifiers to arrive at a frequency. At the determined frequency, the data center can transmit request messages to the buyer's mobile client computer system to input a specific identifier from among those in the set. Based on the response from the buyer's mobile client computer system, the data center can determine that the buyer remains near the home.

The communication from the buyer is received a computer system described below. The computer system executes computer instructions stored on computer-readable media to determine an on-demand real estate agent suited to show the home to the prospective buyer. Upon determining the suitable agent, the computer system notifies the agent about the request from the user. For example, the agent can possess a mobile computer system (such as a smartphone, tablet computer, laptop computer or other mobile computer system) which can receive the notification from the computer server. Using the application, the agent can receive the request, communicate an acceptance of the request, and communicate a departure to meet the customer.

In some examples, the computer server can transmit, to the buyer's mobile computer system, a resource (for example, a Universal Resource Locator (URL)) to identify the agent to the buyer. By selecting the URL, the buyer can view information about the agent (for example, name or picture (or both) or other information about the agent). In some instances, the buyer's mobile client computer system may not be capable of accessing or the buyer may not want to access the URL. In such implementations, the computer server can determine that the URL has not been accessed within a duration after having been transmitted to the buyer's mobile computer system. In such instances, the computer system can communicate information about the agent to the buyer using the same mode of communication (for example, SMS text message) using which the buyer transmitted the request to the computer server.

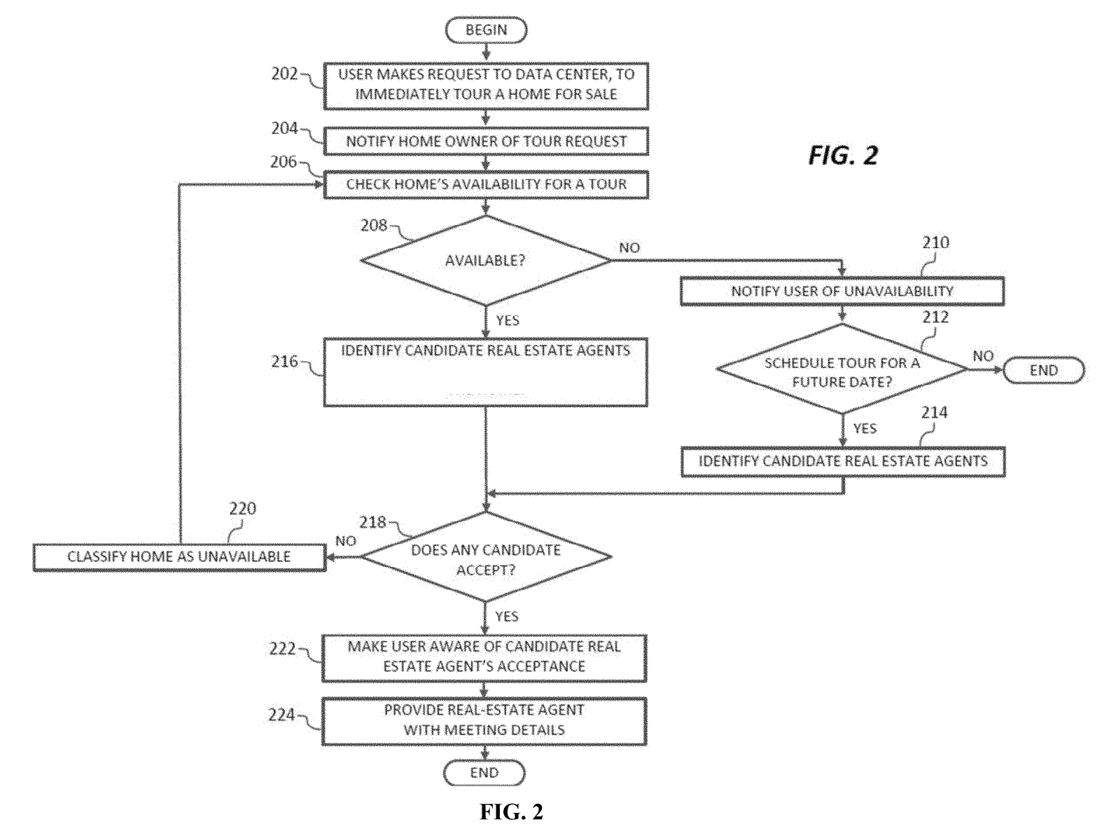

FIG. 2 is a flowchart illustrating an example method for realtor services using the data network, according to an implementation. In some implementations, the method described with reference to FIG. 2 can be implemented by a data center, which can include one or more computer server systems including computer-readable media storing computer instructions to perform each step of the method as computer-implemented operations.

At 202, a user makes a request to a data center to immediately tour a home for sale. For example, the user is at the physical location of the home for sale that they wish to tour. They can use any type of electronic input device to notify the data center, including but not limited to a smartphone, smart watch, tablet, or computer. The request can be initiated via software on the device, such as mobile phone application, SMS message, or other software that can access the data center. The data center will be made aware of the geo-location of the home and thus the requestor. To do so, the user voluntarily provides the geographic coordinates or the data center converts the home address to geographic coordinates.

At 204, a home owner is notified of the tour request. For example, the owner of the home is made aware that a prospective buyer wishes to view the home through some form of electronic message, allowing the home owner to inform the data center of either their approval or denial of entry into the home.

At 206, the availability of the home for a tour is checked. For example, the data center prompts the home owner, asking whether the home is available for a tour. The home owner can grant or deny access. In some implementations, the homeowner can also automate the response to this prompt by setting a schedule in advance, of dates and times when the home is available for a tour.

If the data center determines that the home is not available at checking step 208, then, at 210, the user is notified of the unavailability of the home. At 212, the user is asked if the user wants to schedule a tour for a future date. If the user declines, then the process ends. If the user accepts, then, starting at 214, the user is allowed to specify a date and time that they wish to view the home and a real estate agent is identified to show the home to the user. If the home is determined to be available at checking step 208, then also, starting at 216, a real estate agent is identified to show the home to the user.

At 216, candidate real estate agents are identified. For example, since the home is available for an immediate viewing, the data center identifies a subset of real estate agents that are in the vicinity. The data center broadcasts to each candidate, the user's request, allowing them to respond to the data center with their willingness to participate in the tour. In some implementations, the criteria that determines which real estate agents will be notified can be altered to take such factors into consideration such as distance to home, price of home, and experience of real estate agent. The first real estate agent to respond, which meets the criteria will be selected to respond to the user's request to view the home.

At 218, a check is made to determine if any of the candidate real estate agents accept the request. If no candidate accepts, then at 220, the home is classified as being unavailable. It is possible that there aren't any available real estate agents willing or capable providing a tour of the home. If there are no real estate agent is willing to fulfill the user's request, the data center classifies the home as currently unavailable for touring. The data center notifies the user and can present the user with an option for scheduling a future appointment.

If a candidate accepts, then, at 222, the user is made aware of the candidate real estate agent's acceptance. For example, the data center notifies the user that a real estate agent is nearby and willing to grant entry to the home. In some implementations, the data center can provide additional information such as the estimated arrival of the real estate agent, their name, photo, and even a map tracking their progress, i.e., the agent's travel towards the home.

In some implementations, upon identifying candidate real estate agents, the data center can send notifications to all the agents indicating that they have been identified to potentially show a home. One or more of the candidates can communicate their availability to show the home to the data center. The data center can then present the agents and their availability to the buyer, who can then select an agent. For example, the buyer can select an agent who is available the soonest, is nearest to the home or with whom the buyer has some familiarity. These or other criteria or combination of them can be used by the data center to identify candidate real estate agents to present to the user or by the user to select an agent.

At 224, the real estate agent is provided with meeting details. For example, the data center provides to the real estate agent, details such as exact address of the home. In addition, the data center can provide information such as home specifications including but not limited to price, bedrooms, baths, asking price, listing real estate agent, etc.

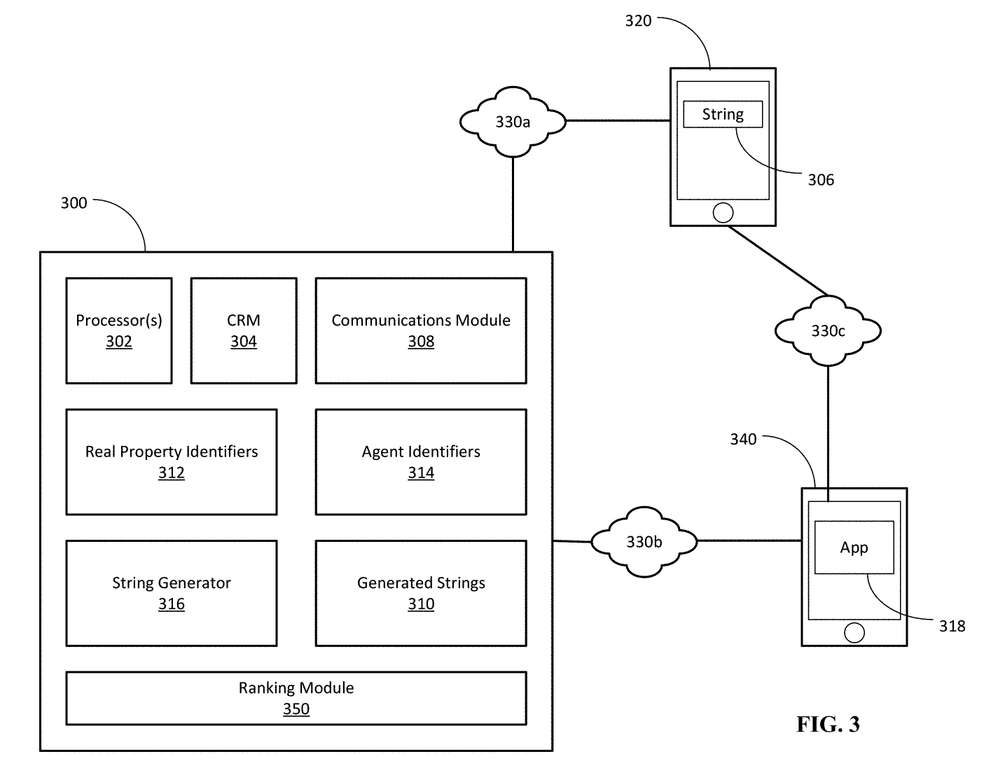

FIG. 3 is a block diagram illustrating an example computer server system 300 used to provide computational functionalities associated with described algorithms, methods, functions, processes, flows, and procedures as described in this disclosure, according to an implementation. The computer server system 300 includes one or more processors 302 and a computer-readable medium 304 storing computer instructions executable by the one or more processors 302 to perform on-demand real estate services. As described in the following paragraphs, the computer server system 300 includes multiple components, each of which can be implemented as computer-readable instructions executable by the one or more processors 302. In some implementations, the components of the system 300 can be installed in the same physical system. Alternatively, each or combinations of the components can be installed in different physical systems that are operatively coupled to each other resulting in a distributed computer server system 300.

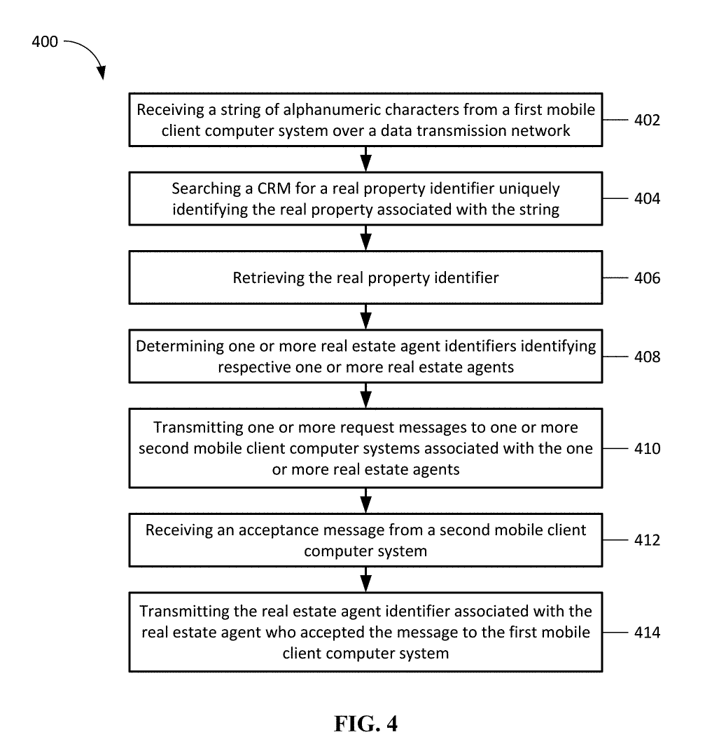

Certain operations performed by the computer server system 300 are described with reference to the flowchart shown in FIG. 4. At 402, a string of alphanumeric characters is received from a first mobile client computer system over a data transmission network. For example, a prospective home buyer possesses the first mobile client computer system 320 (for example, a smart phone, a smart watch, a tablet computer, a laptop computer or other mobile client computer system). The buyer desires to tour a home that is at a geographic location (for example, at a street address or at a Global Positioning System (GPS) coordinate or both). The home is associated with a string (described below) that uniquely identifies the home. The buyer inputs the string 306 into the mobile computer system 320 and transmits the string to the computer server system 300 over the data transmission network 330a. In some implementations, the data transmission network 330a includes a cellular network, and the string 306 is transmitted as a text message via SMS. The computer server system 300 includes a communications module 308 (for example, a transmitter-receiver) that can receive the string 306 via the data transmissions network 330a.

At 404, a computer-readable storage medium (CRM) is searched for a real property identifier that uniquely identifies the real property associated with the string. For example, the computer server system 300 receives the string 306. The computer server system 300 includes or is operatively connected to a computer-readable storage medium that stores multiple strings (generated strings 310), each including multiple alphanumeric characters; multiple corresponding real property identifiers (real property identifiers 312), each uniquely identifying a respective real property, each associated with a corresponding string of the multiple strings; multiple real estate agent identifiers (agent identifiers 314), each identifying a real estate agent qualified to show real property to prospective home buyers; and, for each real estate agent identifier, information describing a qualification of each real estate agent to show the real property to the prospective home buyers. In response to receiving the string 306 over the data transmission network 330a, the computer server system 300 searches the multiple strings stored in the generated strings 310 for the received string 306.

At 406, a real property identifier is retrieved. In response to identifying the string 306, the computer server system 300 searches the real property identifiers 312 to identify and retrieve the real property identifier that corresponds to the string 306. By doing so, the computer server system 300 identifies the home that the prospective buyer desires to tour.

At 408, one or more real estate agent identifiers identifying respective one or more real estate agents are determined. For example, the computer server system 300 searches the agent identifiers 314 to identify agent identifiers that are qualified to show the home identified by the real property identifier to the prospective buyer. To do so, the computer server system 300 compares criteria associated with the home to qualifications associated with the real estate agents stored in the CRM. In one example, the computer server system 300 compares a distance between the home and the current location of each real estate agent. In particular, the computer server system 300 compares GPS coordinates (such as latitude, longitude, altitude) of the home to that of each mobile computer system possessed by each real estate agent and connected to the computer server system 300 when the string 306 is received.

In some implementations, the computer server system 300 can actively track the geographic location of a second mobile client computer system possessed by each real estate agent. To do so, the computer server system 300 can periodically receive (for example, at a frequency of once per second or a greater or lower frequency), GPS coordinates of each second mobile client computer system. Using the received GPS coordinates, the computer server system 300 can determine a distance between the home and each candidate real estate agent. In some implementations, the computer server system 300 can track the distance as the shortest distance between the geographic coordinates of the home and that of a second mobile client computer system. In some implementations, the computer server system 300 can implement cartographical services to determine, for example, a shortest driving distance between the home and the second mobile client computer system, turn-by-turn directions to travel to the home and the like.

In another example, the computer server system 300 compares a price of the home to a price range at which each real estate agent possesses prior experience to sell homes. In particular, the computer server system 300 stores, with real property identifiers 312, prices of the real properties identified by the real property identifiers. The computer server system 300 stores, with agent identifiers, prices of homes previously sold or currently being sold by real estate agents. The computer server system 300 identifies candidate real estate agents based on the comparison of the prices stored with the real property identifiers and the prices stored with the agent identifiers 314. Additional examples of criteria implemented by the client computer system 300 to identify candidate real estate agents are described below.

At 410, one or more request messages are transmitted to one or more second mobile client computer systems associated with the one or more real estate agents identified at 408. For example, as described above, each real estate agent possesses a respective second mobile client computer system, such as second mobile computer system 340), which can be, for example, a smart phone, a smart watch, a tablet computer, a laptop computer or other mobile computer system. Each second mobile computer system possessed by each of the identified candidate real estate agents is connected to the computer server 300 when the string 306 was received. To each second mobile client computer system, the computer server 300 transmits a request message comprising the real property identifier. For example, the second mobile computer system 340 receives a request message over a data transmission network 330b that includes the real property identifier that identifies the real property associated with the input string 306. In some implementations, the second mobile computer system 340 executes a computer software application that displays the request message as a notification. The data transmission network 330b can be a cellular network, a Wi-Fi network, a Bluetooth network, or any other type of wired or wireless network.

At 412, an acceptance message is received from a second mobile client computer system. For example, one or more of the candidate real estate agents can transmit, using their respective second mobile computer systems, acceptance messages accepting the request to show the home to the buyer over the data transmission network 330b. In some implementations, more than one candidate real estate agent can transmit respective acceptance messages. The computer server system 300 can select the first acceptance message that is received, and transmit notifications to the remaining second mobile computer systems that another real estate agent has already accepted the request to show the home.

At 414, the real estate agent identifier associated with the real estate agent who accepted the message is transmitted to the first client computer system. For example, the computer server system 300 transmits to the first mobile client computer system 320 and over the data transmission network 330a the real estate agent identifier including a name and a current location of the real estate agent who accepted the request message. In some implementations, the data transmission network 330a can also include a Wi-Fi network, a Bluetooth network, or any other wired or wireless network. Using the information included with the real estate agent identifier, the first mobile client computer system 320 can display information about the real estate agent and allow the user to track a progress of the real estate agent towards the home.

In some implementations, the computer server system 300 can generate a resource that includes the real estate agent identifier identifying the determined real estate agent and at least some of the qualifications of the agent. The computer server system 300 can generate a Uniform Resource Locator (URL) to identify the resource. The computer server system 300 can transmit, to the first mobile client computer system 320, the URL. In response to input, the first mobile client computer system 320 can access the resource identified by the URL and present the information about the real estate agent, for example, a name, prior sales experience, or other information in a display of the first mobile client computer system 320.

By implementing the process described with reference to FIG. 4, the first mobile client computer system 320 can transmit an on-demand request for a real estate agent identifier to the computer server system 300. By on-demand, it is meant that the computer server system 300 can implement the search for real estate agent identifiers and determine one of the real estate agent identifier in response to and as soon as possible after receiving the on-demand request from the first mobile client computer system 320. Also, by on-demand, it is meant that the computer server system 300 transmits a determined real estate agent identifier to the first mobile client computer system 320 as soon as possible after receiving the request from the first mobile client computer system 320. Any delay in transmitting the determined real estate agent identifier is due to time for the computer server system 300 to search for candidate real estate agents, send messages to the one or more second mobile client computer systems possessed by the identified agents, and to receive an acceptance message from at least one of the second mobile client computer systems.

As described above, the computer server system 300 includes or is operatively connected to a computer-readable storage medium that stores multiple strings (generated strings 310), each including multiple alphanumeric characters; multiple corresponding real property identifiers (real property identifiers 312), each uniquely identifying a respective real property, each associated with a corresponding string of the multiple strings; multiple real estate agent identifiers (agent identifiers 314), each identifying a real estate agent qualified to show real property to prospective home buyers; and, for each real estate agent identifier, information describing a qualification of each real estate agent to show the real property to the prospective home buyers. In some implementations, the computer server system 300 can periodically receive the multiple real property identifiers, real estate agent identifiers and information describing the qualification of each real estate agent and store the received information in the computer-readable storage medium. For example, a real estate agent representing the home owner can manually enter information to the computer server system 300. Alternatively, or in addition, the client computer system 300 can crawl servers of brokerages or other home listing websites to identify available homes for sale.

In some implementations, the computer server system 300 can generate the strings of alphanumeric characters, each of which uniquely identifies a real property. The computer server system 300 can map a string to a respective real property identifier. The computer server system 300 can transmit each string to each real property identified by the respective real property identifier. A home owner or a listing real estate agent can prominently display the string at or near the home (for example, next to a “FOR SALE” sign displayed next to the home) allowing a user to identify the home to the computer server system 300 using the string.

In some implementations, the computer server system 300 can identify a subset including two or more real estate agent identifiers (and less than all the real estate agent identifiers) from among the agent identifiers 314. The computer server system 300 rank the real estate agent identifiers in the subset based on the information describing the qualification of each real estate agent represented by a real estate agent identifier included in the subset. The computer server system 300 can identify a highest ranked real estate agent identifier as a candidate real estate agent to show the home.

In some implementations, the computer server system 300 can include a ranking module 350 that can rank the real estate agents based on each agent's qualifications to show homes. The ranking module 350 can be implemented as computer instructions executable by the one or more processors 302. As described earlier, in some implementations, the computer server system 300 identifies a candidate set of real estate agents to whom the computer server system 300 transmits requests to show the home to a buyer who has transmitted an on-demand request to tour the home. Also as described earlier, the computer server system 300 stores agent identifiers 314 that identifies real estate agents and each agent's qualifications to show homes. The ranking module 350 can divide the real estate agents into multiple candidate subsets. The multiple candidate sets can include multiple tiered subsets (for example, tier 1 subset, tier 2 subset . . . tier n subset). The multiple candidate sets can also include a premier subset or an exclusion subset or both. The ranking module 350 can assign real estate agent identifiers to one of the subsets based on implementing certain rules.

For example, real estate agent identifiers assigned to the premier subset have the highest priority of all the real estate agent identifiers 314. Real estate agent identifiers assigned to the tiered subsets have a lower priority than the real estate agent identifiers assigned to the premier subset. The number of real estate agent identifiers in each tiered subset is the same. Within the tiered subsets, a real estate agent identifier assigned to a lower numbered subset (for example, tier 1 subset) has a higher priority than that assigned to a comparatively higher numbered subset (for example, tier 5 subset). Real estate agent identifiers assigned to the exclusion tier are not considered when ranking the candidate real estate agent identifiers.

Each real estate agent identifier is associated with a real estate agent who possesses a second mobile client computer system that is connected to the computer server system 300 when the request from the first mobile client computer system 320 is received. Each second mobile client computer system provides, to the computer server system 300, information using which the computer server system 300 determines a geographic location (for example, a physical location) of the second mobile client computer system, and consequently, the real estate agent in possession of the second mobile client computer system. Using the geographic location information of the connected second mobile client computer systems, the computer server system 300 determines, as an initial classification, real estate agent identifiers that are within a predetermined distance from the geographic location of the home. In the initial classification, the real estate agent identifiers are not arranged in any specific order.

In some implementations, the ranking module 350 can add a real estate agent identifier to the initial classification even though the initial classification excluded the identifier based on geographic proximity to the home. For example, if a real estate agent identifier is identified as the listing agent for the home, then the ranking module 350 can add the real estate agent identifier to the initial classification even if the agent identified by the real estate agent identifier is farther away from the home than the specified distance used to determine the initial classification.

In some implementations, the ranking module 350 can develop a second classification representing a time for each real estate agent identified by a respective identifier in the first classification to travel to the home. For example, for each identifier in the initial classification, the ranking module 350 can access traffic in a route from a geographic location of the agent identified by each identifier and the home. Based on the traffic, the ranking module 350 300 can determine a time for each agent to reach the home. Based on the times, the ranking module 350 can assign one or more real estate agent identifiers to respective subsets but not the premier subset or the exclusion subset. Thus, the ranking module 350 assigns at least one real estate agent identifier to each of tier 1 subset, tier 2 subset, . . . tier n subset. When the second classification has been developed, the premier subset and the exclusion subset are nulls.

Subsequently, the ranking module 350 retrieves the rules to re-assign real estate agent identifiers to the tiers. Each rule represents a criterion that the ranking module 350 considers to determine a rank for a real estate agent identifier. The criteria include a tenure or experience of an agent, home price, brokerage, whether real estate agent identified by the identifier is a listing agent, whether the real estate agent identified by the identifier has paid a fee to increase rank, a frequency with which a real estate agent identifier is selected, any combination of these criteria or other criteria defined by an administrator of the computer server system 300. Each rule is associated with a value. The ranking module 350 combines multiple values associated with multiple rules to arrive at a rank for each real estate agent identifier. Based on the rank, the ranking module 350 assigns each real estate agent identifier to a tier.

For example, the ranking module 350 can move up, by at least one tier, a real estate agent identifier identifying a real estate agent who has more than a threshold number of years of experience being an agent. If the price of the home is greater than a threshold price, then the ranking module 350 can move down, by at least one tier, a real estate agent identifier identifying a real estate agent, for example, who does not have experience selling homes at or above the threshold price. If the home has been advertised by a particular brokerage and a real estate agent is not associated with the particular brokerage (as determined from the information associated with the real estate agent), the ranking module 350 can assign the real estate agent to the exclusion subset. Similarly, if a real estate agent identifier is associated with certain qualifications, then the ranking module 350 can assign the real estate agent to the premier subset. If more than one rule applies to the real estate agent identifier, then the values associated with the applicable rules can be mathematically combined (for example, added or otherwise combined) to determine the subset to which the ranking module 350 assigns the identifier. The result is ranked list of subsets of real estate agent identifiers.

In some implementations, the rank assigned to the real estate agent identifiers can be used to determine an order in which the agents are notified of the buyer's desire to tour the home. For example, initially (for example, at time=t₀), the computer server system 300 can transmit the request messages only to the real estate agent identifiers assigned to the premier subset, and not to the real estate agent identifiers in any of the other subsets or to those that were not included in the initial classification. Doing so gives the agents assigned to the premier subset the first opportunity to accept the buyer's request. After a delay of a certain time duration (for example, 5 seconds, 10 seconds, 15 seconds, 20 seconds, or other time duration less than one minute), at time=ti, the computer server system 300 can transmit the request messages only to the real estate agent identifiers assigned to the tier 1 subset, and not to the real estate agent identifiers in any of the other subsets or to those that were not included in the initial classification. After a delay of a certain time duration from ti, the computer server system 300 can transmit the request messages only to the real estate agent identifiers assigned to the tier 2 subset, and not to the real estate agent identifiers in any of the other subsets or to those that were not included in the initial classification. In this manner, the computer server system 300 can stagger the transmission of the request messages to the real estate agent identifiers in the different subsets.

In some implementations, the computer server system 300 can transmit the request messages to all the real estate agent identifiers in all the subsets (except the exclusion subset) at substantially the same time. For example, the computer server system 300 can transmit multiple request messages in parallel. When acceptance messages are received from the real estate agent identifiers, the computer server system 300 can utilize the ranking to prioritize presenting the real estate agent identifier to the first mobile client computer system. To do so, the computer server system 300 can stagger the transmission of the real estate agent identifiers to the first mobile client computer system 320 by implementing techniques similar to those described above.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., or less than 5 secs. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM), or both. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously-described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously-described implementations should not be understood as requiring such separation or integration in all implementations, and it should be understood that the described program components and systems can generally be integrated together in a single software product or packaged into multiple software products.

Accordingly, the previously-described example implementations do not define or constrain this disclosure. Other changes, substitutions, and alterations are also possible without departing from the spirit and scope of this disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
receiving, by one or more computer server systems and from a first mobile client computer system over a data transmission network, a string of alphanumeric characters, the string identifying a real property at a geographic location;
in response to receiving the string, searching, by the one or more computer server systems, a computer-readable storage medium for a real property identifier uniquely identifying the real property identified by the received string, the computer-readable storage medium storing:
a plurality of strings, each including a plurality of alphanumeric characters,
a corresponding plurality of real property identifiers, each real property identifier uniquely identifying a respective real property, each real property identifier associated with a corresponding string of the plurality of strings,
a plurality of real estate agent identifiers, each real estate agent identifier identifying a real estate agent qualified to show real property to prospective home buyers, and
for each real estate agent identifier, information describing a qualification of each real estate agent to show the real property to the prospective home buyers;
in response to searching for the real property identifier uniquely identifying the real property identified by the received string:
retrieving, by the one or more computer server systems and from the computer-readable storage medium, the real property identifier uniquely identifying the real property identified by the received string, and
determining, by the one or more computer server systems, based on the information describing the qualification of each real estate agent to show the real property to the prospective home buyers, one or more real estate agent identifiers, each identifying a real estate agent qualified to show the real property at the geographic location; and
transmitting, by the one or more computer server systems to one or more second mobile client computer systems associated with the respective identified one or more real estate agent identifiers and over the data transmission network, a request message to each real estate agent identified by each of the one or more real estate agent identifiers, the request message requesting each real estate agent to show the real property at the geographic location, the second mobile client computer system associated with the real estate agent determined to show the real property at the geographic location.

2. The method of claim 1, further comprising:
in response to transmitting the request message to each real estate agent, receiving, by the one or more computer server systems and from a second mobile computer system over the data transmission network, an acceptance message accepting the request message, the second mobile device associated with a real estate agent identifier included in the determined one or more real estate agent identifiers; and
in response to receiving the acceptance message, transmitting, by the one or more computer server systems and to the first mobile client computer system, the real estate agent identifier identifying the real estate agent and at least a portion of the qualification of the identified real estate agent that is associated with the identified real estate agent identifier.

3. The method of claim 2, further comprising:
generating, by the one or more computer server systems, a resource comprising the real estate agent identifier identifying the determined real estate agent and at least the portion of the qualification; and
generating a Uniform Resource Locator (URL) to identify the resource, wherein transmitting the real estate agent identifier and at least the portion of the qualification to the first mobile client computer system comprises transmitting the URL to the first mobile client computer system.

4. The method of claim 1, wherein transmitting the request message to the second mobile client computer system is performed on an on-demand basis in response to receiving the string of alphanumeric characters.

5. The method of claim 1, further comprising:
receiving the plurality of real property identifiers;
receiving the plurality of real estate agent identifiers;
receiving, for each real estate agent identifier, the information describing the qualification of each real estate agent to show the real property to the prospective home buyers; and
storing the received plurality of real property identifiers, received plurality of real estate agent identifiers and the received information for each real estate agent in the computer-readable storage medium.

6. The method of claim 5, further comprising:
generating, by the one or more computer server systems, the plurality of strings of alphanumeric characters for the corresponding plurality of real property identifiers; and
storing the plurality of strings of alphanumeric characters in the computer-readable storage medium.

7. The method of claim 6, further comprising transmitting, by the one or more computer server systems to each real property identified by a respective real property identifier and over the data transmission network, a corresponding string of alphanumeric characters.

8. The method of claim 1, wherein the string of alphanumeric characters comprises a telephone number, wherein the data transmission network is a cellular network, and wherein the request message is a text message sent via Short Message Service (SMS).

9. The method of claim 1, wherein determining, by the one or more computer server systems, based on the information describing the qualification of each real estate agent to show the real property to the prospective home buyers, the real estate agent identifier identifying the real estate agent to show the real property at the geographic location comprises:
identifying a subset of real estate agent identifiers from among the plurality of real estate agent identifiers, the subset having at least two real estate agent identifiers and fewer real estate agent identifiers than the plurality of real estate agent identifiers;
ranking the subset based on the information describing the qualification of each real estate agent represented by a real estate agent identifier included in the subset; and
identifying a real estate agent identifier associated with a highest ranked real estate agent.

10. The method of claim 9, wherein transmitting, by the one or more computer server systems to one or more second mobile client computer systems associated with the respective identified one or more real estate agent identifiers and over the data transmission network, a request message to each real estate agent identified by each of the one or more real estate agent identifiers comprises:
transmitting, to a second mobile client computer system associated with a higher ranked real estate agent identifier, a first request message at a first time instant;
delaying a request message transmission by a duration from the first time instant; and
transmitting, to a second mobile client computer system associated with a lower ranked real estate agent identifier, a second request message at a second time instant after the duration has expired.

11. The method of claim 9, wherein the subset is ranked based on a price associated with the real property.

12. A computer-readable medium storing one or more instructions executable by one or more computer systems to perform operations comprising:
receiving, from a first mobile client computer system over a data transmission network, a string of alphanumeric characters, the string identifying a real property at a geographic location;
in response to receiving the string, searching a computer-readable storage medium for a real property identifier uniquely identifying the real property identified by the received string, the computer-readable storage medium storing:
a plurality of strings, each including a plurality of alphanumeric characters,
a corresponding plurality of real property identifiers, each real property identifier uniquely identifying a respective real property, each real property identifier associated with a corresponding string of the plurality of strings;
in response to searching for the real property identifier uniquely identifying the real property identified by the received string:
retrieving, from the computer-readable storage medium, the real property identifier uniquely identifying the real property identified by the received string, and
determining, based on information describing a qualification of each real estate agent to show real property to prospective home buyers, a real estate agent identifier identifying a real estate agent to show the real property at the geographic location;
transmitting, to a second mobile client computer system associated with the identified real estate agent identifier and over the data transmission network, a request message to show the real property at the geographic location, the second mobile client computer system associated with the real estate agent determined to show the real property at the geographic location;
in response to transmitting the request message to show the real property at the geographic location, receiving, from the second mobile computer system over the data transmission network, an acceptance message accepting the request message; and
in response to receiving the acceptance message, transmitting, to the first mobile client computer system, the real estate agent identifier identifying the determined real estate agent and at least a portion of the qualification of the identified real estate agent that is associated with the identified real estate agent identifier.

13. The medium of claim 12, wherein the operations further comprise:
generating a resource comprising the real estate agent identifier identifying the determined real estate agent and at least the portion of the qualification; and
generating a Uniform Resource Locator (URL) to identify the resource, wherein transmitting the real estate agent identifier and at least the portion of the qualification to the first mobile client computer system comprises transmitting the URL to the first mobile client computer system.

14. The medium of claim 12, wherein the operations further comprise:
receiving a plurality of real property identifiers;
receiving a plurality of real estate agent identifiers;
receiving, for each real estate agent identifier, information describing a qualification of each real estate agent to show real property to prospective home buyers; and
storing the received plurality of real property identifiers, received plurality of real estate agent identifiers and the received information for each real estate agent in the computer-readable storage medium.

15. The medium of claim 14, wherein determining, based on the information describing the qualification of each real estate agent to show the real property to the prospective home buyers, the real estate agent identifier identifying the real estate agent to show the real property at the geographic location comprises:
identifying a subset of real estate agent identifiers from among the plurality of real estate agent identifiers, the subset having at least two real estate agent identifiers and fewer real estate agent identifiers than the plurality of real estate agent identifiers;
ranking the subset based on the information describing the qualification of each real estate agent represented by a real estate agent identifier included in the subset; and
identifying a real estate agent identifier associated with a highest ranked real estate agent.

16. The medium of claim 15, wherein transmitting, by the one or more computer server systems to one or more second mobile client computer systems associated with the respective identified one or more real estate agent identifiers and over the data transmission network, a request message to each real estate agent identified by each of the one or more real estate agent identifiers comprises:
transmitting, to a second mobile client computer system associated with a higher ranked real estate agent identifier, a first request message at a first time instant;
delaying a request message transmission by a duration from the first time instant; and
transmitting, to a second mobile client computer system associated with a lower ranked real estate agent identifier, a second request message at a second time instant after the duration has expired.

17. The medium of claim 15, wherein the subset is ranked based on a price associated with the real property.

18. A computer-implemented system comprising:
a computer memory; and
a hardware processor interoperably coupled with the computer memory and configured to perform operations comprising:
receiving, from a first mobile client computer system over a data transmission network, a string of alphanumeric characters, the string identifying a real property at a geographic location;
in response to receiving the string, searching, a computer-readable storage medium for a real property identifier uniquely identifying the real property identified by the received string, the computer-readable storage medium storing:
a plurality of strings, each including a plurality of alphanumeric characters,
a corresponding plurality of real property identifiers, each real property identifier uniquely identifying a respective real property, each real property identifier associated with a corresponding string of the plurality of strings,
a plurality of real estate agent identifiers, each real estate agent identifier identifying a real estate agent qualified to show real property to prospective home buyers, and
for each real estate agent identifier, information describing a qualification of each real estate agent to show the real property to the prospective home buyers;
in response to searching for the real property identifier uniquely identifying the real property identified by the received string:
retrieving, from the computer-readable storage medium, the real property identifier uniquely identifying the real property identified by the received string, and
determining, based on the information describing the qualification of each real estate agent to show the real property to the prospective home buyers, a real estate agent identifier identifying a real estate agent to show the real property at the geographic location; and
transmitting, to a second mobile client computer system associated with the identified real estate agent identifier and over the data transmission network, a request message to show the real property at the geographic location, the second mobile client computer system associated with the real estate agent determined to show the real property at the geographic location.

19. The system of claim 18, the operations further comprising:
in response to transmitting the request message to show the real property at the geographic location, receiving, from the second mobile computer system over the data transmission network, an acceptance message accepting the request message; and
in response to receiving the acceptance message, transmitting, to the first mobile client computer system, the real estate agent identifier identifying the determined real estate agent and at least a portion of the qualification of the identified real estate agent that is associated with the identified real estate agent identifier.

20. The system of claim 18, wherein determining, based on the information describing the qualification of each real estate agent to show the real property to the prospective home buyers, the real estate agent identifier identifying the real estate agent to show the real property at the geographic location comprises:
identifying a subset of real estate agent identifiers from among the plurality of real estate agent identifiers, the subset having at least two real estate agent identifiers and fewer real estate agent identifiers than the plurality of real estate agent identifiers;
ranking the subset based on the information describing the qualification of each real estate agent represented by a real estate agent identifier included in the subset; and
transmitting a request message to a highest ranked real estate agent before transmitting the request message to any other real estate agent.
